(19) United States
(12) Patent Application Publication
(10) Pub. No.: US 2009/0248655 A1
(43) Pub. Date: Oct. 1, 2009

(54) Method and Apparatus for Providing Sponsored Search Ads for an Esoteric Web Search Query

(76) Inventor: Evgeniy Makeev, Cupertino, CA (US)

Correspondence Address: STATTLER - SUH PC, 60 SOUTH MARKET STREET, SUITE 480, SAN JOSE, CA, 95113, US

(21) Appl. No.: 12/055,773

(22) Filed: Mar. 26, 2008

(51) Int. Cl. G06F 17/30

(52) U.S. Cl. 707/5; 707/E17.108

(57) ABSTRACT

A method and apparatus are included for providing sponsored search ads for an esoteric Web search query. In one example, the method includes receiving search results and a request for placement of sponsored ads onto a search results page, retrieving bidder term vectors associated with every search result URL of the search results, calculating for every bidder term a weight associated with a given search result set, sorting bidder terms by their weight that is associated with a given search result set, and returning sponsored search ads for bidder terms with higher weights.

### FIELD OF THE INVENTION

The present invention relates to sponsored search advertising on the Internet. More particularly, the present invention relates to sponsored search advertising for esoteric Web search queries.

### BACKGROUND OF THE INVENTION

An advertiser, such as Ford® or McDonald's®, generally contracts a creative agency for ads to be placed in various media for the advertiser's products. Such media may include TV, radio, Web ads (e.g., banner display ads, textual ads, streaming ads, mobile phone ads), print media ads (e.g., ads in newspapers, magazines and posters).

Sponsored search ads can be a particularly effective means of advertising. Sponsored search ads are typically a list of links that appear at the top or the right of a search results page. A sponsored search ad is related to the consumer's search query. An advertiser gets priority in a sponsored search placement by bidding on particular terms that may appear in consumer search queries. These terms are called bidder terms. In other words, a bidder term is a term that advertisers bid on to receive priority ad placement on a search results page after a consumer performs a search for that particular bidder term.

The sponsored search advertising marketplace generates billions of dollars in revenue each year for a search engine, for example, Yahoo!®. The search marketing marketplace works on a cost-per-click (CPC) model. When a consumer performs a search query online and clicks on a sponsored search text ad, a company like Yahoo!® is paid by the respective advertiser. Consumers tend to click on more relevant ads. It is the company's best interest to show the most relevant ads to consumers, in order to get more clicks on these ads. In order to do this, the company needs to gather information about consumers' search behavior and click behavior. Search behavior is what the consumer searches. Primary evidence for search behavior is the key words used in the consumer search. Click behavior is what the consumer click on the search page after a search. The clicks may include clicking to select an ad, clicking to close an ad, etc. The company can then use this information to target relevant ads to different consumers.

In the CPC model, there are two important events—search events and click events. Search events occur when a consumer performs a search query. Click events occur when a consumer clicks on a sponsored text ad. Web servers of a company like Yahoo!® collect search events when a consumer performs a query on the company's search page. URLs (uniform resource locators) of the ads on the search result webpage may contain the click event information. The company wants to collect and analyze the search and click events in order to build a model for query-to-text ad relevance. If the company can learn which ads are more relevant, then the company can target these ads to consumers and get a higher click-through rate.

It turns out that Web search content space is much larger and more diverse than sponsored search content space. As a result of the larger content space and mature Web search technology, Web search results are usually of a higher quality and relevance then sponsored search results. When consumers are presented with a search result page which contains both Web search results and sponsored search results, the majority of consumer clicks (feedback) will go to Web search part of the results, especially for complicated or rear queries.

FIG. 1 is an example Yahoo!® search results page 100 for the esoteric search query for “P235/60R-16”, which is a particular tire size. For explanatory purposes, this query for “P235/60R-16” is shown to have produced zero (0) sponsored search results while providing about 900 Web search results (4 results shown). There are no search results because the limited sponsored search content does not have any appropriate documents containing the word “P235/60R-16” in its crawled content, bidder term title or creative filtering. It does not mean that the Yahoo!® Sponsored Search advertisers do not sell this type of tires. On the contrary, most of the Yahoo!® tire advertisers do sell this tire size. However, that word “P235/60R-16” is sufficiently esoteric that it does not appear on the advertisers' HTML (hypertext markup language) pages. Further, none of the advertisers bid on this specific word or advertise it because of its esoteric nature.

On the other hand, a query for the generic word “tire” (http://us.search.yahoo.com/search?fr=lo&p=tire) returns plenty of sponsored search results. Further, just about every one of the returned advertisers sells the P235/60R-16 tire size.

Unfortunately, there is currently no way for a search engine company like Yahoo!® to use Web search results to link an esoteric query, such as “P235/60R-16”, to a more generic bidder term, such as “tire”. Thus, the search engine company cannot provide relevant Sponsored Search results to the consumer who searched for an esoteric term like “P235/60R-16”.

### SUMMARY OF THE INVENTION

What is needed is an improved method having features for addressing the problems mentioned above and new features not yet discussed. Broadly speaking, the present invention fills these needs by providing a method and apparatus for providing sponsored search ads for an esoteric Web search query. It should be appreciated that the present invention can be implemented in numerous ways, including as a method, a process, an apparatus, a system or a device. Inventive embodiments of the present invention are summarized below.

In one embodiment, a method is provided for obtaining statistics on Web search results. The method comprises receiving search results of multiple consumer queries, building a table in which every search result URL selected by a consumer serves as a key, associating a vector of bidder terms with every key in the table, adding every unique query which led to a selection of a search result URL into a corresponding URL vector and maintaining a summary term weight inside the corresponding URL vector, sorting all selected search result URLs for a specified time period and selecting bidder terms with the highest summary term weight for each recorded URL, and insert the selected bidder terms in the web search documents associated with the corresponding URLs.

In another embodiment, a method is provided for returning sponsored search ads for an esoteric Web search query, the method comprises receiving search results and a request for placement of sponsored ads onto a search results page, retrieving bidder term vectors associated with every search result URL of the search results, calculating for every bidder term a weight associated with a given search result set; and sorting bidder terms by their weight that is associated with a given search result set.

In still another embodiment, an apparatus is provided for obtaining statistics on Web search results, the apparatus comprises a receiver device configured to receive search results of multiple consumer queries; and an offline calculator device configured to build a table in which every search result URL selected by a consumer serves as a key, and further configured to associate a vector of bidder terms with every key in the table, and further configured to add every unique query which led to a selection of a search result URL into a corresponding URL vector and maintain a summary term weight inside the corresponding URL vector, and further configured to sort all selected search result URLs for a specified time period and select bidder terms with the highest summary term weight for each recorded URL, and further configured to insert the selected bidder terms in the web search documents associated with the corresponding URLs.

In yet another embodiment, an apparatus is provided for returning sponsored search ads for an esoteric Web search query. The apparatus comprises a receiver device configured to receive search results and a request for placement of sponsored ads onto a search results page; and an runtime calculator device configured to retrieve bidder term vectors associated with every search result URL of the search results, and further configured to calculate for every bidder term a weight associated with a given search result set, and further configured to sort bidder terms by their weight that is associated with a given search result set.

In still yet another embodiment, a computer readable medium carrying one or more instructions for returning sponsored search ads for an esoteric Web search query is provided. The one or more instructions, when executed by one or more processors, cause the one or more processors to perform the steps of receiving search results and a request for placement of sponsored ads onto a search results page, retrieving bidder term vectors associated with every search result URL of the search results, calculating for every bidder term a weight associated with a given search result set, and sorting bidder terms by their weight that is associated with a given search result set.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is an example Yahoo!® search results page for the esoteric search query for “P235/60R-16”, which is a particular tire size;

FIG. 2 is a block diagram of a system for providing sponsored search ads for an esoteric web search query, in accordance with an embodiment of the present invention;

FIG. 3 is a schematic diagram of a system for providing sponsored search ads for an esoteric web search query, in accordance with an embodiment of the present invention;

FIG. 4 is a flowchart of an offline method of obtaining statistics on Web search results in order to provide data for providing sponsored search ads, in accordance with an embodiment of the present invention;

FIG. 5 is a flowchart of a runtime method of providing sponsored search ads for an esoteric Web search query, in accordance with an embodiment of the present invention; and

FIG. 6 is an example Yahoo!® search results page for a search query for the esoteric term “P235/60R-16”, in accordance with an embodiment of the present invention.

### DETAILED DESCRIPTION OF THE INVENTION

An invention for a method and apparatus for providing sponsored search ads for an esoteric Web search query is disclosed. Numerous specific details are set forth in order to provide a thorough understanding of the present invention. It will be understood, however, to one skilled in the art, that the present invention may be practiced with other specific details.

### General Overview

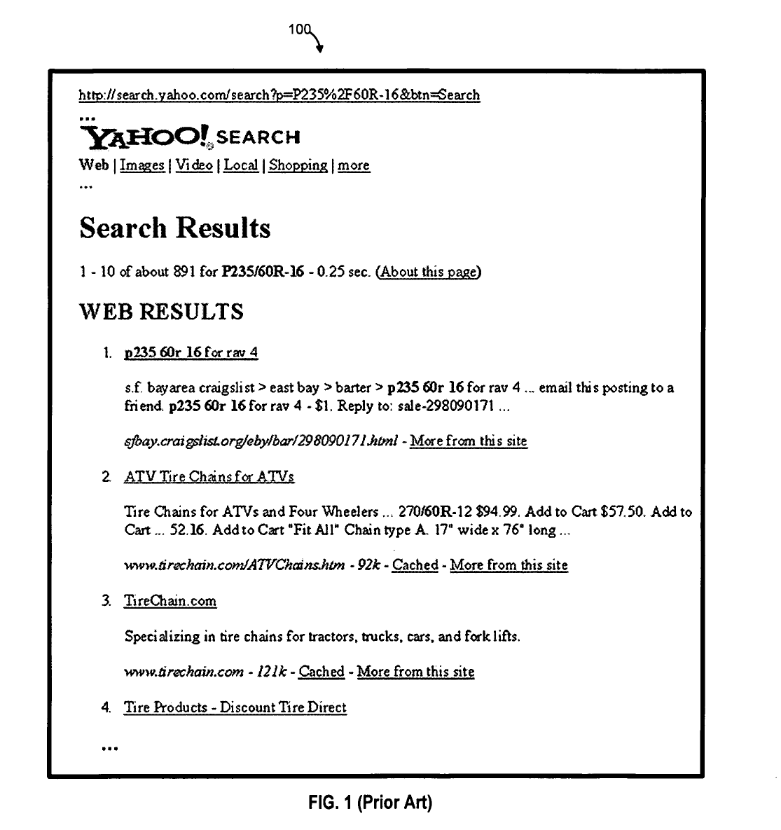

Referring to FIG. 1, the system of the present invention provides a way for a search engine company like Yahoo!® to use Web search results to link an esoteric query, such as “P235/60R-16”, to a more generic bidder term, such as “tire”. A bidder term is a term that advertisers bid on to receive priority ad placement on a search results page after a consumer performs a search for that particular bidder term. The search engine company can then return plenty of relevant Sponsored Search results to a consumer who performs an esoteric search.

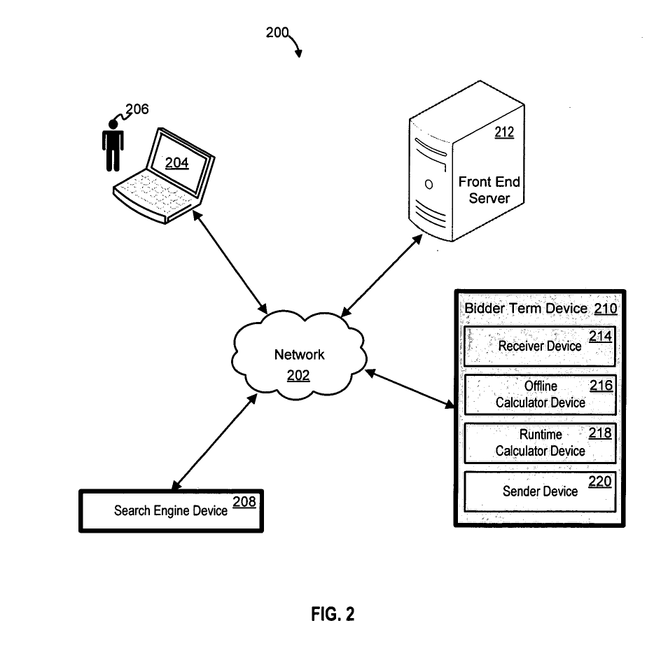

FIG. 2 is a block diagram of a system 200 for providing sponsored search ads for an esoteric web search query, in accordance with an embodiment of the present invention. A device of the present invention is hardware, software or a combination thereof. A device may sometimes be referred to as an apparatus. Each device is configured to carry out one or more steps of the method of providing sponsored search ads for an esoteric web search query.

A network 202 couples together a consumer computer 204, a search engine device 208, a front end server 212 and a bidder term device 210 (i.e., YSTBT or web search bidder term device). The network 202 may be any combination of networks, including without limitation the Web (i.e., the Internet), a local area network, a wide area network, a wireless network and a cellular network. The bidder term device 210 includes without limitation a receiver device 214, an offline calculator device 216, a runtime calculator device 218 and a sender device 220. In an alternative embodiment, the front end server 212 includes the bidder term device 210. The front end server 212 may also be referred to as a customized web server.

The system 200 associates a vector of N most popular sponsored search bidder terms with every (or most) web documents in web search databases. The system 200 can easily request and retrieve this vector with every web search result by the search engine device 208 (i.e., web search/sponsored search backend). So, when the system 200 is about to provide a search result page (with typically ten results) to the consumer computer 204 for the consumer 206, the bidder term device 210 in the backend system will have access to ten bidder term vectors.

The bidder term device 210 can then select a number of the most popular bidder terms from these vectors (probably giving some preference to the bidder terms from the vectors belonging to the top search results) and then find ads from advertisers bidding on the selected bidder terms. This finding of ads is substantially the only runtime part of the proposed solution. The system 200 can perform offline the more complicated and time consuming task of associating bidder term vectors with billions of web search database documents. This offline activity is described further below.

For explanatory purposes, the consumer 206 and the devices of the system 200 may be referred to as being singular. However, the embodiment is not so limited. For example, the system 200 is configured to receive many searches from many different consumers.

### ILLUSTRATIVE EXAMPLES

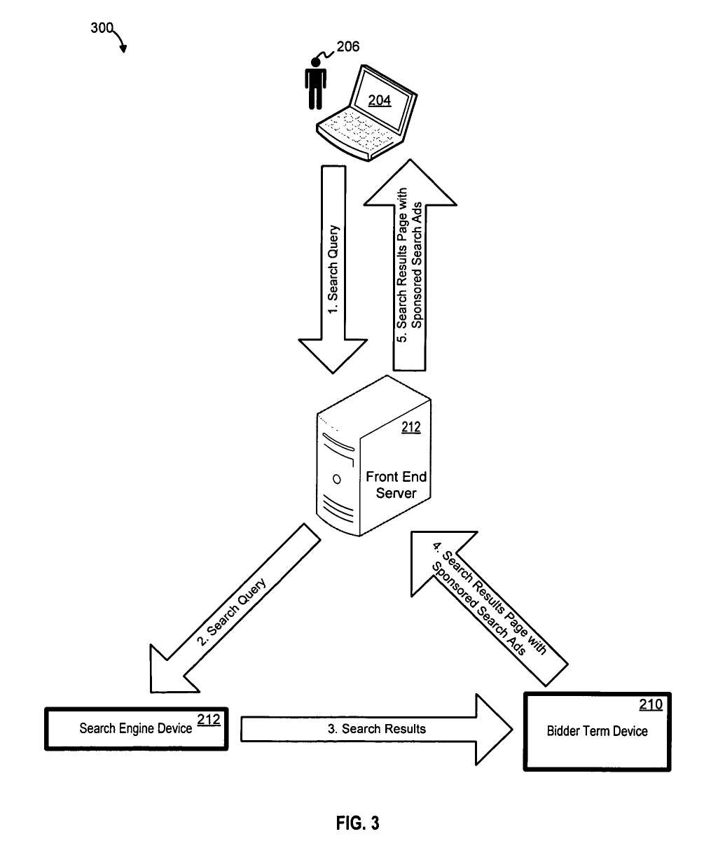

FIG. 3 is a schematic diagram of a system 300 for providing sponsored search ads for an esoteric web search query, in accordance with an embodiment of the present invention. The core of the system 300 is the bidder term device 210, which uses web search consumer feedback to associate bidder terms with search result documents.

The front end server 212 receives search queries from consumer computers 204. The search engine device 212 receives the search queries from the front end server 212 and sends the search results to the bidder term device 210. The bidder term device 210 processes web search click logs and finds all consumer queries which are also sponsored search bidder terms or contain sponsored search bidder terms. Next, for those queries, the bidder term device 210 finds all web search documents (URLs) selected (clicked on) by consumers. The bidder term device then attaches, to a particular web search document, the N most popular bidder terms that resulted in the most consumer clicks on the document. As mentioned above with reference to FIG. 2, the bidder term vector is N bidder terms long.

Now, the bidder term vectors are in web search documents. The system 300 can retrieve these documents during a regular web search query and retrieve the ads corresponding to the most popular bidder terms in the retrieved vectors.

The following description is one example of a simple way to implement the proposed solution. The implementation is based on four tunable parameters described here.

V is the maximum number of bidder terms (i.e., query term vector) associated with web search result URLs/documents.

R is the maximum number of query rewrites generated during runtime.

CW is the click weight, which is a measurement of consumer preference for a particular search result URL; when presented with N search results, consumers tend to give preference to the search results on the top of the page; it means that if a consumer selected a search result closer to the bottom of the page, this selection should be assigned a higher weight the farther from the top of the page it is.

RW is the result weight; when generating search result pages, search engines put “better” or more relevant results on the top of the pages and put less important or relevant results on the bottom. Accordingly, during runtime bidder term selection, the system 300 should give higher weight to URLs (i.e., results) and their bidder term vectors on the top of the pages.

### Offline Part of Implementation

Referring to FIG. 3, the offline part of the implementation is described further in the following example. The bidder term device 210 receives, from the search engine search device 212, search results of multiple consumer queries.

First, the bidder term device 210 builds a table where every search result URL selected (clicked on) by a consumer serves as a key in this table. Over time, the bidder term device 210 develops a statistical pattern of search and click behavior of consumers.

Second, the bidder term device 210 then associates a vector of queries (i.e., bidder terms) with every key in the table.

Third, for every unique query which led to a consumer click on a search result URL, the bidder term device 210 adds that unique query to a corresponding URL vector and also maintains the summary term weight (STW) inside this vector. So, for every occurrence of the click on the URL/document for a specific bidder term, the bidder term device 210 adds the following to the STW: 1+CW*P, where P is the position of the URL on the result page (0-9 for a ten result page). Accordingly, STW can be expressed, for example, as . . .

STWᵢ=Σ(1+CW*Pⱼ), where i and j are integers. Equation 1

TABLE 1
URLs have Corresponding Bidder Terms and STWs, where M
and N are integers.

| | | |
|---|---|---|
| URL(0) | Term₀(0) | STW₀(0) |
| | . . . | . . . |
| | Term₀(M₀ − 1) | STW₀(M₀ − 1) |
| . . . | | |
| URL(N − 1) | Term_{(N-1)}(0) | STW_{(N-1)}(0) |
| | . . . | . . . |
| | Term_{(N-1)}(M_{(N-1)} − 1) | STW_{(N-1)}(M_{(N-1)} − 1) |

Fourth, after the bidder term device 210 processes all click data (i.e., selected URL data) for a specified period of time, the bidder term device 210 sorts all bidder term vectors by their STW and selects up to V bidder terms with the highest STW for each recorded URL.

Fifth, the bidder term device 210 inserts the selected bidder terms into the web search documents associated with the corresponding URLs. The offline part of the implementation is then complete.

Now, the bidder term vectors are in web search documents. The bidder term device 210 can retrieve the bidder term vectors during a regular web search query and retrieve the ads corresponding to the most popular bidder terms in the retrieved vectors. This retrieving of the ads is described further below in the runtime part of the implementation.

### Runtime Part of Implementation

The runtime part of the implementation is described further in the following example. In this part, the system 300 preferably takes no more than about 20 milliseconds to carry out its processes because the consumer 206 is waiting. In this part, the system 300 is finding sponsored search results after the statistics were gathered on the web search results in the offline part discussed above.

The search engine device 212 receives a search query. The search engine device 212 selects the best N (usually 10) URLs (i.e., results) and eventually returns the URLs to the front end server 212 (i.e., the client). However, right after the search ending device 212 selects the search results and before the search results are passed on to the front end server 212, the bidder term device 210 performs some processing. In other words, the bidder term device 210 receives a request for placement of sponsored ads onto a search results page and then performs some processing.

First, the bidder term device 210 retrieves all bidder term vectors associated with every search result (i.e., URL) the search engine returns.

Second, for every bidder term, the bidder term device 210 calculates a weight (RTW) associated with the given result set. The weight may be calculated as follows: per every occurrence of a bidder term in a vector RTW is incremented by 1+RW*(N−1−P), where N is the total number of results returned by the search engine, and where P is the position of the result in the result set (top is 0, bottom is N−1), and where RTW can be expressed, for example, as . . .

RTWᵢ=Σ(1+RW*(N−Pⱼ−1)), where j is an integer from 0 to the number of bidder term occurrences, and where i is an integer. Equation 2.

Third, the bidder term device 210 sorts the bidder terms by their RTW and returns sponsored search results (i.e., sponsored search ads) for up to R bidder terms with the highest RTW. In sum, this runtime process involves displaying particular sponsored search ads every time particular search result URLs appear on a search results page.

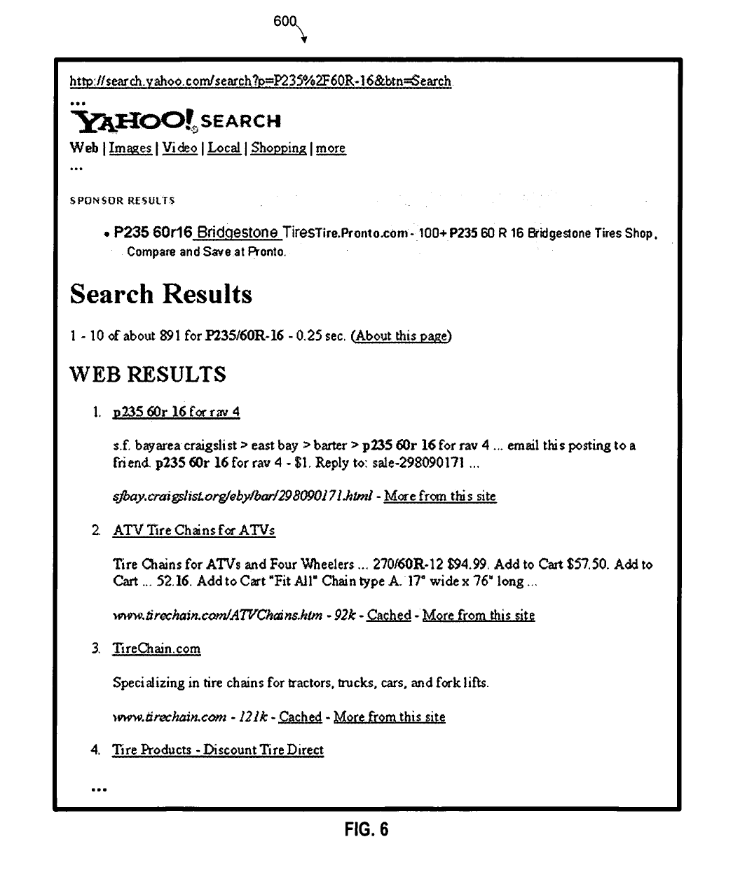

FIG. 6 is an example Yahoo!® search results page 600 for a search query for the esoteric term “P235/60R-16”, in accordance with an embodiment of the present invention. The system provided to the consumer computer a search results page 600 that includes sponsor results (i.e., sponsored search ads or sponsored search results), and also search results, in response to the search query for the esoteric query “P235/60R-16”. In this example, the sponsor results include one advertisement from Bridgestone® Tires.

Note that the system can cache the whole process to produce a table of query rewrites for later user. Also, note that the embodiments of the present invention are not limited to the particular equations described. These equations can be modified and still be within the scope of the present invention.

### Method Outline

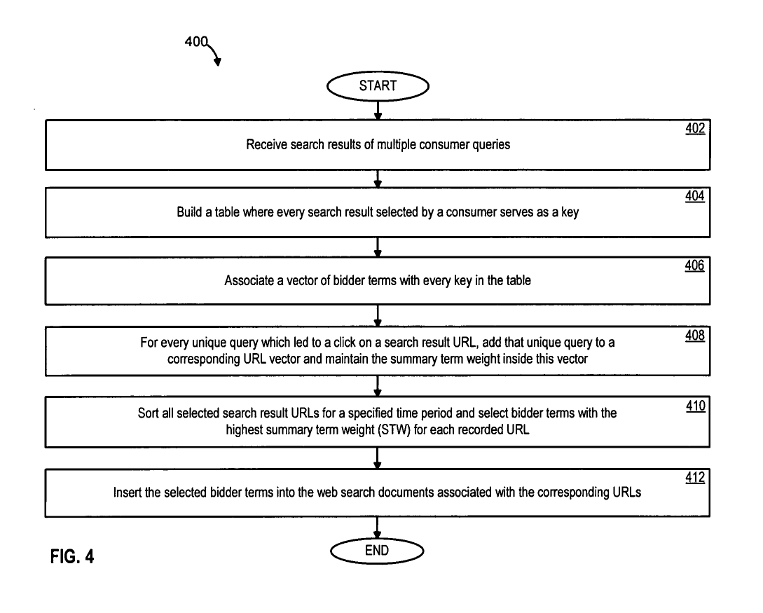

FIG. 4 is a flowchart of an offline method 400 of obtaining statistics on Web search results in order to provide data for providing sponsored search ads, in accordance with an embodiment of the present invention. In a preferred embodiment, the bidder term device 210 of FIG. 3 carries out the steps of this offline method 400.

The offline method 400 starts in step 402 where the system receives search results of multiple consumer queries. Then, the system builds a table where every search result selected (i.e., clicked) by a consumer serves as a key. The offline method 400 then moves to step 406 where the system associates a vector of bidder terms with every key in the table. In step 408, for every unique query which led to a click (i.e., selection) on a search result URL, the system adds that unique query to a corresponding URL vector and maintains the summary term weight inside this vector. Next, in step 410, the system sorts all selected search result URLs for a specified time period and selects bidder terms with the highest summary term weight (STW) for each recorded URL. The offline method 400 then moves to step 412 where the system inserts the selected bidder terms into the Web search documents associated with the corresponding URLs. The offline method 400 is then at an end.

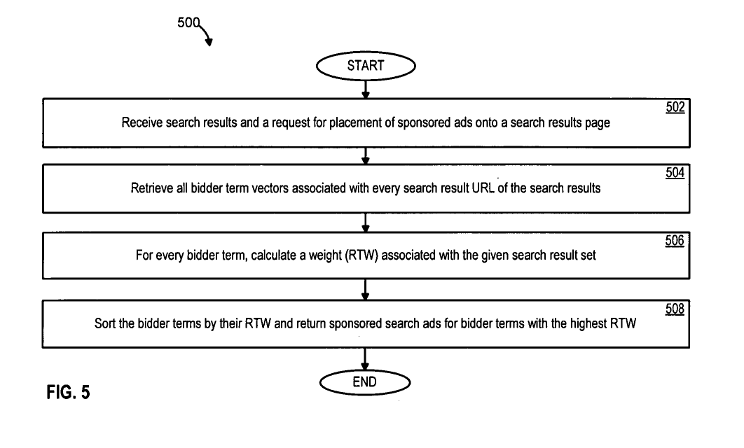

FIG. 5 is a flowchart of a runtime method 500 of providing sponsored search ads for an esoteric Web search query, in accordance with an embodiment of the present invention. In a preferred embodiment, the bidder term device 210 of FIG. 3 carries out the steps of this runtime method 500.

The runtime method 500 starts in step 502 where the system receives search results and a request for placement of sponsored ads onto a search results page. Then, in step 504, the system retrieves all bidder term vectors associated with every search result URL of the search results. In step 506, for every bidder term, the system calculates a weight (RTW) associated with the given search result set. The runtime method 500 then proceeds to step 508 where the system sorts the bidder terms by their RTW and returns sponsored search ads for bidder terms with the higher RTWs. The runtime method 500 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation receiving search results and a request for placement of sponsored ads onto a search results page, retrieving bidder term vectors associated with every search result URL of the search results, calculating for every bidder term a weight associated with a given search result set, and sorting bidder terms by their weight that is associated with a given search result set, according to processes of the present invention.

### Advantages

The system of the present invention will allow a company like Yahoo!® to produce relevant sponsored search ads based solely on Web search result pages. Web search has extremely large and diverse content databases, so the potential ad coverage gains may be significant.

As soon as the sponsored search results are displayed alongside Web search results, it is important that the ads correspond to the Web search results. Existing sponsored search technologies do not always provide this kind of correspondence.

The system of the present invention also provides a relatively simple and clean way to associate bidder terms with Web search documents by using Web search consumer feedback.

Even when some Web search results suffer from poor query relevancy consumers are not likely to click on irrelevant results, but only on results which are relevant to the specific query. So, associating bidder terms based on consumer feedback will eliminate unneeded noise and will tend to correct Web search results' inaccuracies if present.

The system of the present invention does not rely on exact query words presence anywhere in the sponsored search documents. So, the system may provide significant coverage increases for the queries which currently have zero ad coverage since most of the existing technologies rely on exact query words matching.

Most of the complexity of the described methods falls under offline feedback log processing. The runtime part of the methods is simple and fast and will allow the system to find relevant ads without significant increases in Web search query latencies.

The system uses (1) consumer feedback to associate Web search documents with Sponsored Search bidder terms and (2) Web search results to find sponsored search ads. Note that using Web search results to find ads is not a new idea. However, the method of using bidder term associations makes using Web search results practical due to the extremely large volume of Web search databases, which distinguishes it from existing products and proposals.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of obtaining statistics on Web search results, the method comprising:
receiving search results of multiple consumer queries;
building a table in which every search result URL selected by a consumer serves as a key;
associating a vector of bidder terms with every key in the table;
adding every unique query which led to a selection of a search result URL into a corresponding URL vector and maintaining a summary term weight inside the corresponding URL vector;
sorting all selected search result URLs for a specified time period and selecting bidder terms with the highest summary term weight for each recorded URL; and
insert the selected bidder terms in the web search documents associated with the corresponding URLs.

2. The method of claim 1, wherein the method is performed offline from Web search queries.

3. The method of claim 1, wherein the building the table comprises developing a statistical pattern of search and click behavior of consumers.

4. The method of claim 1, wherein the selecting bidder terms with the highest summary term weight comprises selecting up to a specified maximum number of bidder terms associated with web search result URLs.

5. The method of claim 1, wherein the summary term weight is dependant on a click weight, wherein the click weight is a measurement of consumer preference for a particular search result URL.

6. A method of returning sponsored search ads for an esoteric Web search query, the method comprising:
receiving search results and a request for placement of sponsored ads onto a search results page;
retrieving bidder term vectors associated with every search result URL of the search results;
calculating for every bidder term a weight associated with a given search result set; and
sorting bidder terms by their weight that is associated with a given search result set.

7. The method of claim 6, wherein the method is performed during runtime of a Web search query.

8. The method of claim 6, further comprising returning sponsored search ads for bidder terms with higher weights.

9. The method of claim 6, wherein the method is performed after a search engine device selects search results and before the search results are passed to a front end server.

10. The method of claim 8, wherein the returning sponsored search ads comprises returning sponsored search ads for up to a specified maximum number of bidder terms.

11. The method of claim 6, further comprising displaying a particular sponsored search ad if a particular search result URL appears on the search result page.

12. The method of claim 6, wherein the esoteric Web search query includes at least one term that is typically not a bidder term.

13. An apparatus for obtaining statistics on Web search results, the apparatus comprising:
a receiver device configured to receive search results of multiple consumer queries; and
an offline calculator device configured to build a table in which every search result URL selected by a consumer serves as a key, and further configured to associate a vector of bidder terms with every key in the table, and further configured to add every unique query which led to a selection of a search result URL into a corresponding URL vector and maintain a summary term weight inside the corresponding URL vector, and further configured to sort all selected search result URLs for a specified time period and select bidder terms with the highest summary term weight for each recorded URL, and further configured to insert the selected bidder terms in the web search documents associated with the corresponding URLs.

14. The apparatus of claim 13, wherein the offline calculator device is further configured to develop a statistical pattern of search and click behavior of consumers.

15. The apparatus of claim 13, wherein the offline calculator device is further configured to select up to a specified maximum number of bidder terms associated with web search result URLs.

16. The apparatus of claim 13, wherein the summary term weight is dependant on a click weight, wherein the click weight is a measurement of consumer preference for a particular search result URL.

17. An apparatus for returning sponsored search ads for an esoteric Web search query, the apparatus comprising:
a receiver device configured to receive search results and a request for placement of sponsored ads onto a search results page; and
an runtime calculator device configured to retrieve bidder term vectors associated with every search result URL of the search results, and further configured to calculate for every bidder term a weight associated with a given search result set, and further configured to sort bidder terms by their weight that is associated with a given search result set.

18. The apparatus of claim 17, further comprising a sender device configured to return sponsored search ads for bidder terms with higher weights.

19. The apparatus of claim 17, wherein the apparatus is configured to be active after a search engine device selects search results and before the search results are passed to a front end server.

20. The apparatus of claim 18, wherein the sender device is further configured to return sponsored search ads for up to a specified maximum number of bidder terms.

21. A computer readable medium carrying one or more instructions for returning sponsored search ads for an esoteric Web search query, wherein the one or more instructions, when executed by one or more processors, cause the one or more processors to perform the steps of:
receiving search results and a request for placement of sponsored ads onto a search results page;
retrieving bidder term vectors associated with every search result URL of the search results;
calculating for every bidder term a weight associated with a given search result set; and
sorting bidder terms by their weight that is associated with a given search result set.
